(19) United States
(12) Patent Application Publication
(10) Pub. No.: US 2014/0267357 A1
(43) Pub. Date: Sep. 18, 2014

(54) ADAPTIVE IMPORTANCE SAMPLING FOR POINT-BASED GLOBAL ILLUMINATION

(71) Applicant: DreamWorks Animation LLC, (US)

(72) Inventors: Bruce Nunzio TARTAGLIA, Santa Monica, CA (US); Chris F. Armsden, Burbank, CA (US)

(73) Assignee: DreamWorks Animation LLC, Glendale, CA (US)

(21) Appl. No.: 13/844,436

(22) Filed: Mar. 15, 2013

(51) Int. Cl. G06T 11/40

(52) U.S. Cl. CPC G06T 11/40
USPC 345/589

(57) ABSTRACT

A computer-enabled method for shading locations for use in rendering a computer-generated scene having one or more objects represented by a point cloud. The method involves selecting a shading location, selecting a set of points from the point cloud, rasterizing the points onto a raster shape positioned at the shading location, where the raster shape has varying texel densities that are based on characteristics of the points in the point cloud, such that the texel density varies on different surfaces of the raster shape or on different areas of the same surface or both, and shading the shading location.

### BACKGROUND

1. Field

The present disclosure relates generally to computer graphics, and more specifically to computer systems and processes for using adaptive importance sampling to efficiently render a scene using point-based global illumination (PBGI).

2. Description of Related Art

Global illumination is a technique used in computer graphics to add more realistic lighting to a scene. One global illumination approach is known as the point-based global illumination (PBGI) approach. PBGI generally involves solving indirect illumination integrals and occlusion integrals. Before these integrals are solved, the directly illuminated geometry in the scene is represented by a point cloud representation, which is generated in a pre-computation phase prior to the rendering of the scene.

A point cloud is a model that may be used to represent a surface and/or volume of an object using a set of points (which may also be called “emitter points”), with each point representing a position in three-dimensional space. In one example, an emitter point may be a data representation of a surfel, which is a small, disk-shaped surface element making up the different objects within a scene. In this example, the surfaces of different objects are subdivided into small micropolygons (or surfels), and the light energy emitting from each micropolygon (e.g., the radiance) is stored with each emitter point. An emitter point can also store other information, including a position, a surface normal, an effective area, a point-radius, and the like.

To efficiently solve the illumination integrals with PBGI, the generated point cloud may be further organized into a multi-resolution level of detail hierarchy. For example, an octree data structure may be used to partition the three-dimensional space represented by a point cloud by recursively subdividing the space into eight octants. An octree data structure is a tree data structure wherein each internal node has up to eight child nodes. Leaf nodes in the octree store the individual emitter points of the point cloud. Each non-leaf node stores an emitter point cluster, which is an approximation of a collection of emitter points situated within a particular volume. For example, an emitter point cluster representation includes an average position for the emitter point cluster, as well as the projected area and emitted energy when the emitter point cluster is viewed from various directions (the directional projected area and directional emitted energy, respectively).

After generating the octree hierarchy, both the full point cloud and the octree hierarchy may then be used to compute the indirect illumination integrals and occlusion integrals at all “shading locations” (which may also be called “receiver points”) seen from a virtual camera. The choice of specific emitter point nodes or emitter point clusters used for rendering a scene depends on the desired visual quality of the scene.

After the point cloud and octree have been generated, the scene is rasterized. To raster the scene, each receiver point is conceptually “covered” by a three-dimensional raster shape, which may be a cube, hemicube, or hemisphere, for example. Each side of the raster shape is partitioned into texels (texture elements). The texels represent the energy contributions of a set of emitter point nodes or emitter point clusters, as viewed from the perspective of the covered receiver point. The scene (as represented by the emitter points) is projected as an image onto each side of the raster shape, with each side representing a slightly different perspective of the scene. The texels are then sampled and used as inputs to the occlusion and illumination integrals that compute the final shading value for the shading location and render the scene.

In the process outlined above, the texel density (which may be referred to as the raster resolution) affects the visual quality of the rendered scene; a higher texel density leads to better visual quality because the integrals include more samples.

In traditional PBGI rastering approaches, the texel density is uniform across all surfaces of the raster shape. Because higher texel densities yield higher scene resolutions, one way to increase the photorealism of a rendered scene is to increase the density of texels on the entire raster shape. However, increasing the texel density increases rendering time and memory usage. Furthermore, a level of resolution that is suitable for one area of a raster shape on which the scene is projected may not be suitable for another area, due to differences in the resolution required by different areas of a projected scene. Therefore, a technique for adapting the texel density based on the characteristics of the scene to be rendered is proposed.

### BRIEF SUMMARY

In one exemplary embodiment, a computer-animated scene illuminated by indirect light is shaded. The scene is comprised of sample locations on a surface element of an object in the scene. The surface element lies at least partially within a camera viewing frustum of a virtual camera. A point cloud representation of the scene is generated by dividing the surface of the object in the scene into one or more micropolygons and storing the position, area, radius and normal value of each micropolygon with its corresponding point. The point may have an associated energy (radiance) value also if the point cloud is being used for illumination. In this case, the point may be called an “emitter point.”

A set of emitter points representing a scene or a portion of a scene may be selected from the point cloud. The scene may then be rendered using a rasterization process in which the texel density on the raster shape is non-uniform and is adjusted based on one or more characteristics of scene as represented by the selected emitter points. The resulting texels may then be sampled and used to compute the illumination integrals and shade the scene.

### DESCRIPTION OF THE FIGURES

The present application can best be understood by reference to the following description taken in conjunction with the accompanying drawing figures, in which like parts may be referred to by like numerals.

FIG. 1 depicts a scene and a point cloud representation of the scene.

FIG. 2 depicts an exemplary process according to the present disclosure for shading receiver points based on characteristics of a point cloud for rendering a computer-generated scene.

FIGS. 3A-B depict hemicubes with various texel densities.

FIG. 4 depicts an exemplary computing system that may be used to implement an exemplary process according to the present disclosure.

### DETAILED DESCRIPTION

The following description sets forth numerous specific configurations, parameters, and the like. It should be recognized, however, that such description is not intended as a limitation on the scope of the present invention, but is instead provided as a description of exemplary embodiments.

This disclosure describes processes for rendering a scene using PGBI-based rasterization with adaptive texel densities. Previous processes for rasterizing a scene using PBGI techniques relied on the user setting an acceptable level of detail for an entire scene (e.g., by setting an appropriate uniform texel density for the raster shape). The processes described herein adapt the texel density for different areas of the raster shape based on characteristics of points in the point cloud. The points of the point cloud may be called “emitter points” in that these points are emitting light that may affect the shading of the points that are being shaded, which may be called “receiver points.”

PBGI techniques typically accept a point cloud of emitter points as an input. The output of the PBGI techniques is applied to a set of receiver points that are used to shade a scene. At each receiver point, the scene represented by a set of emitter points is rasterized (e.g., projected) onto a raster shape, which may be a cube, hemicube, or hemisphere, for example. Each side of the raster shape is divided into texels, which represent the light received from the set of emitter points as viewed from the perspective of the receiver point. Texel samples are then used to compute the illumination integrals and shade the location of the receiver point.

The density of the texels on the raster shape affects the quality of the rendered scene; higher texel densities yield a higher level of detail within the scene. Previous PBGI rasterization techniques have used uniform texel densities, and relied on the user setting an acceptable level of detail for the receiver points being shaded (e.g., by setting an appropriate uniform texel density). These techniques do not allow for changing the level of detail based on the lighting characteristics of the scene. An exemplary shading process is described below that allows for more efficient shading of receiver points by using non-uniform texel densities for rasterization that vary based on characteristics of the scene as represented by points in the point cloud. For example, as the luminance of a scene or portion of a scene increases, the energy associated with the corresponding emitter points also increases. The location and energy information associated with the emitter points may be used to adapt the texel densities such that the densities are higher in certain areas of the raster shape or on some sides of the raster shape.

FIG. 1 provides one example of a point cloud representation of objects that are rendered in a scene. Scene 300 may represent a shot taken by a virtual camera 370 viewing a virtual world of teapots, including teapot 310. A point cloud representation 360 of teapot 310 may be computed. To generate the point cloud, the surfaces of different objects in the scene 300, such as teapot 310, may be subdivided into small micropolygons. The energy (e.g., light) reflected (and/or emitted) from each micropolygon may be stored as an energy value in an emitter point associated with the micropolygon in the point cloud. An emitter point may also store other information, including a position, a surface normal, an effective area, a point-radius, or the like. Shading location 320 in the scene 300 may correspond to receiver point 390 in the point cloud representation 350 of the scene 300. Note that in this case, receiver point 390 may also be in the point cloud as an emitter point. However, this may not always be the case.

The point cloud may be generated from the point of view of virtual camera 370. This limits the number of emitter points to those visible by the camera, removing any emitter points outside the camera's field of view (outside of frustum 380) or occluded by other objects within the scene. However, in other cases it may be necessary to include emitter points that are not visible by the camera. The point cloud representation 350 of the scene 300 may be generated in a pre-computation phase before computing the shading of the receiver points for use in shading the scene.

The emitter points of point cloud representation 350 may be used to iteratively shade the receiver points necessary for rendering (e.g., shade) the pixels of scene 300. For example, the projections of the receiver points in-view may be mapped through the camera projection onto the rendered image plane to form scene 300. The distribution of receiver points may be generated so that once the receiver points are projected through the camera projection onto the rendered image plane, the receiver points are approximately pixel-sized and pixel-spaced.

Further discussion of point clouds and how point clouds may be used to render images may be found in U.S. patent application Ser. No. 12/842,986, filed Jul. 23, 2010, and entitled “Optimal Point Density Using Camera Proximity for Point-Based Global Illumination” and U.S. patent application Ser. No. 13/156,213, filed Jun. 8, 2011, and entitled “Coherent Out-of-Core Point-Based Global Illumination” (hereinafter “Coherent OOC PBGI”), each of which is herein incorporated by reference in its entirety.

Point clouds have previously been used to create importance maps to guide ray-tracing algorithms. Ray-tracing is a technique used to achieve global illumination in an animated scene, and is an alternative to point-based global illumination. Further discussion of the use of point clouds for guiding ray-tracing can be found in U.S. patent application Ser. No. 13/174,385, filed Jun. 30, 2011, and entitled “Point-Based Guided Importance Sampling,” herein incorporated by reference in its entirety.

The point cloud used for the exemplary processes described below may be shaded prior to shading the receiver points necessary to render a scene. For example, initially, a point cloud may be shaded using only direct illumination. Next, based on the directly illuminated point cloud, the point cloud (or a different point cloud representing the same virtual world) may be reshaded to account for a single bounce of indirect illumination. This process may be repeated as necessary to create point clouds with an arbitrary number of bounces of light. Once a properly shaded point cloud is obtained, the point cloud may be used to shade a set of receiver points for use in rendering the scene. It should be understood that the receiver points that are shaded may or may not be represented in the point cloud of emitter points. In other words, a receiver point may also be an emitter point, but a receiver point may also not have a corresponding emitter point.

FIG. 2 illustrates an exemplary process 200 for rendering a scene. In step 210 of process 200, a point cloud representation of the scene is generated using, for example, a 3D scanning technique or other approach.

In step 220 of process 200, a shading location (e.g., an unshaded receiver point in the set of receiver points to be shaded) is selected for shading. In one example, the shading location is a receiver point that may be selected from the set of all receiver points that are to be used in rendering a scene.

In step 230 of process 200, a set of emitter points is selected for shading the shading location selected in step 220. The set of emitter points may be a plurality of emitter points in the point cloud, or may be an emitter point cluster. In one example, the set of emitter points may be selected based on a suitable level of detail (also called a “cut”). For instance, the suitable level of detail may be set by defining a desired solid angle for emitter point clusters.

In step 240 of process 200, the points are rasterized. In one example, the selected emitter points representing a scene or a portion of a scene are rasterized onto a raster shape having non-uniform texel densities. In one example, the texel densities may be determined based on the characteristics of the set of points selected in step 230. Such characteristics may include, for example, location and energy information associated with the emitter points. Other characteristics may be used in addition to or instead of the location and energy.

In another example, the texel densities may be determined based on an importance map that identifies areas of interest within a scene. The importance map may be generated by, for example, performing a pre-pass analysis of the point cloud to determine areas of interest. This pre-pass analysis may be performed during a pre-image-rendering computation phase.

The importance map may contain information including, but not limited to, the energy of the emitter point, its position relative to the sample location, identification information, or the like. This information may also be used to designate one or more “areas of interest” in the scene. As used herein, “area of interest” refers to any area within a scene which may contribute information important to the illumination of the scene. For example, an “area of interest” may include, but is not limited to, areas of high radiance, high contrast, relative contrast, or the like. Further, each scene may have zero or more areas of interest. These areas of interest may provide the greatest contributions to the shading of the scene.

The importance map may be built starting from the point cloud representation. In one example, the points in the point cloud representation are clustered into point clusters, which are approximations of a collection of points situated within a particular volume. The points are then projected onto a cube located at the shading location. The cube may represent energy that passes through the sample location, accounting for volumetric effects. For example, energy may pass through sample locations on translucent objects, such as clouds, skin, hair, or the like. The cube may also account for multiple levels of indirect illumination, such as may be considered when rendering ice.

The cube may be a hemicube. A hemicube represents a cube that has been cut in half, and has five surfaces rather than six (a hemicube has no bottom surface). A hemicube may be used when the sample location is on a solid object, such as a table, a wall, or the like.

This energy information may be used to determine which areas of the image have the most radiance, energy, contrast, or the like, thus defining the areas of interest. For example, areas of interest may be defined by areas that exceed a given threshold, areas that exceed a relative threshold, the top n areas of most energy, radiance, contrast, or the like (where n is an integer representing a cut-off value), areas within a relative distance, any combination of some or all of these metrics, or the like.

For example, an area of interest may be identified by integrating the area on the cube, hemicube, or the like. If the energy value is over a given threshold, such as 0.3 on a scale of 0-1 (with 0 being black and 1 being white), then the area may be designated as an area of interest. Alternatively, an area of interest may be identified by areas of contrast. For example, a black and white checkerboard may be an area of high contrast since each block of the checkerboard is a different color. In this case, higher texel densities may be required for the rasterization process used for rendering in order to accurately represent these contrast areas.

One of ordinary skill in the art will recognize there are other ways to build an importance map. For example, an importance may be built manually, by using an automated process, or by some combination of manual and automated process. Other methods, metrics, and thresholds may be used in place of, or in addition to, those described above.

In another example, the texel densities may also be determined based in part on characteristics of the BRDF (bi-directional reflectance distribution function) or corresponding BRDF importance function for the shading location. The BRDF characterizes surface reflective properties, such as whether a surface is glossy or diffuse. In another example, the texel densities may be determined based on an environment map.

One of ordinary skill in the art will recognize there are other ways to use characteristics of a scene or characteristics of a set of emitter points to select non-uniform texel densities for a raster shape.

The texel densities may be selected to vary between surfaces of the raster shape, such that one surface of the raster shape has a different density than another surface of the raster shape. For example, the surface of the raster shape that is parallel to the receiver point's associated micropolygon (a surface that may be called the “up-surface”) may have a texel density that is greater than the texel densities of the other surfaces of the raster shape. The texel densities may also be selected to vary across a single surface of the raster shape, such that one area of one surface has a different density from another area of the same surface.

FIGS. 3A-B depict hemicubes with various texel densities. In FIG. 3A, the texel density on the up-surface 301 is greater than the texel densities on other hemicube surfaces 302 (not all of which are visible). In FIG. 3B, the texel density on the up-surface is higher in one area 303 of the up-surface than in another area 304 of the up-surface. Although FIGS. 3A-3B depict higher texel densities on the up-surface, the higher texel densities may be used on other surfaces of the raster shape instead of (or in addition to) on the up-surface. A person having ordinary skill in the art will recognize that many texel density combinations are possible, including three or more texel densities on a single surface of a raster shape, different texel densities on each surface of the raster shape, or two or more texel densities on one or more surfaces with uniform texel densities on the remaining surfaces. These examples are intended for illustrative purposes only; they are not exhaustive.

In step 250, the shading location is shaded. In one example, texel samples from a raster shape generated during the rasterization step 240 are used as inputs to the illumination and occlusion integrals, which are evaluated to determine the overall shading at the shading location.

FIG. 4 depicts an exemplary computing system 1000 configured to perform any one of the above-described processes. In this context, computing system 1000 may include, for example, a processor, memory, storage, and input/output devices (e.g., monitor, keyboard, disk drive, Internet connection, etc.). However, computing system 1000 may include circuitry or other specialized hardware for carrying out some or all aspects of the processes. In one embodiment, computing system 1000 may be configured as a system that includes one or more units, each of which is configured to carry out some aspects of the processes either in software, hardware, or some combination thereof.

FIG. 4 depicts computing system 400 with a number of components that may be used to perform the above-described processes. The main system 402 includes a motherboard 404 having an I/O section 406, one or more central processing units (“CPU”) 408, and an in-core memory section 410, which may have a flash memory card 412 related to it. The I/O section 406 is connected to a display 424, a keyboard 414, an out-of-core disk storage unit 416, and a media drive unit 418. The media drive unit 418 can read/write a non-transistory computer-readable medium 420, which can contain programs 422 and/or data.

At least some values based on the results of the above-described processes can be saved for subsequent use. Additionally, a non-transitory computer-readable medium can be used to store (e.g., tangibly embody) one or more computer programs for performing any one of the above-described processes by means of a computer. The computer program may be written, for example, in a general-purpose programming language (e.g., Pascal, C, C++) or some specialized application-specific language.

Although only certain exemplary embodiments have been described in detail above, those skilled in the art will readily appreciate that many modifications are possible in the exemplary embodiments without materially departing from the novel teachings and advantages of this disclosure. For example, aspects of embodiments disclosed above can be combined in other combinations to form additional embodiments. Accordingly, all such modifications are intended to be included within the scope of this disclosure.

What is claimed is:

1. A computer-enabled method for shading locations for use in rendering a computer-generated scene having one or more objects represented by a point cloud, the method comprising:
selecting a shading location to shade, the shading location associated with an object in the scene;
selecting a set of points from the point cloud;
rasterizing the set of points onto a raster shape positioned at the shading location, wherein the raster shape has one or more areas, wherein the one or more areas comprise a first array of texels having a first density and a second array of texels having a second density, wherein the first density and the second density are not the same, wherein the first density and the second density are determined based on characteristics of the set of points from the point cloud; and
shading the shading location using the first and second arrays of texels.

2. The method of claim 1, wherein the characteristics of the set of points from the point cloud comprise location and energy information.

3. The method of claim 1, wherein the set of points is selected from the group consisting of points from the point cloud and a cluster of points from the point cloud.

4. The method of claim 1, wherein the raster shape is a hemicube.

5. The method of claim 4, wherein a first surface of the hemicube is of the first density of texels and a second surface of the hemicube is of the second density of texels.

6. The method of claim 4, wherein a surface of the hemicube comprises a first area of the one or more areas and a second area of the one or more areas and wherein the first area is of the first density of texels and the second area is of the second density of texels.

7. The method of claim 1, wherein the raster shape is a hemisphere.

8. The method of claim 7, wherein a surface of the hemisphere comprises a first area of the one or more areas and a second area of the one or more areas, wherein the first area is of the first density of texels and the second area is of the second density of texels.

9. The method of claim 1, wherein the raster shape is a cube.

10. The method of claim 1, wherein the first density and the second density are determined based on an importance map, wherein the importance map is generated by:
analyzing the points in a point cloud; and
designating an area of interest based on the energy values of the one or more points in the point cloud.

11. The method of claim 1, wherein the first density and the second density are determined using the BRDF importance function of the shading location.

12. The method of claim 1, wherein the first density and the second density are determined using an environment map.

13. A computer-readable storage medium comprising computer-executable instructions for shading locations for use in rendering a computer-generated scene having one or more objects represented by a point cloud, the computer-readable instructions comprising instructions for:
selecting a shading location to shade, the shading location associated with an object in the scene;
selecting a set of points from the point cloud;
rasterizing the set of points onto a raster shape positioned at the shading location, wherein the raster shape has one or more areas, wherein the one or more areas comprise a first array of texels having a first density and a second array of texels having a second density, wherein the first density and the second density are not the same, wherein the first density and the second density are determined based on characteristics of the set of points from the point cloud; and
shading the shading location using the first and second arrays of texels.

14. The computer-readable storage medium of claim 13, wherein the characteristics of the set of points from the point cloud comprise location and energy information.

15. The computer-readable storage medium of claim 13, wherein the set of points is selected from the group consisting of points from the point cloud and a cluster of points from the point cloud.

16. The computer-readable storage medium of claim 13, wherein the raster shape is a hemicube.

17. The computer-readable storage medium of claim 16, wherein a first surface of the hemicube is of the first density of texels and a second surface of the hemicube is of the second density of texels.

18. The computer-readable storage medium of claim 16, wherein a surface of the hemicube comprises a first area of the one or more areas and a second area of the one or more areas and wherein the first area is of the first density of texels and the second area is of the second density of texels.

19. The computer-readable storage medium of claim 13, wherein the raster shape is a hemisphere.

20. The computer-readable storage medium of claim 19, wherein a surface of the hemisphere comprises a first area of the one or more areas and a second area of the one or more areas, wherein the first area is of the first density of texels and the second area is of the second density of texels.

21. The computer-readable storage medium of claim 13, wherein the raster shape is a cube.

22. The computer-readable storage medium of claim 13, wherein the first density and the second density are determined based on an importance map, wherein the importance map is generated by:
analyzing the points in a point cloud; and
designating an area of interest based on the energy values of the one or more points in the point cloud.

23. The computer-readable storage medium of claim 13, wherein the first density and the second density are determined using the BRDF importance function of the shading location.

24. The computer-readable storage medium of claim 13, wherein the first density and the second density are determined using an environment map.

25. A computer system for shading locations for use in rendering a computer-generated scene having one or more objects represented by a point cloud, the system comprising:
memory configured to store the shading location; and
one or more processors configured to:
select a shading location to shade, the shading location associated with an object in the scene;
select a set of points from the point cloud;
rasterize the set of points onto a raster shape positioned at the shading location, wherein the raster shape has one or more areas, wherein the one or more areas comprise a first array of texels having a first density and a second array of texels having a second density, wherein the first density and the second density are not the same, wherein the first density and the second density are determined based on characteristics of the point cloud; and
shade the shading location using the first and second arrays of texels.
